(19) United States
(12) Patent Application Publication
(10) Pub. No.: US 2007/0147674 A1
(43) Pub. Date: Jun. 28, 2007

(54) Method and system for computer aided detection of high contrast objects in tomographic pictures

(76) Inventor: Lutz Gundel, Erlangen (DE)

Correspondence Address: HARNESS, DICKEY & PIERCE, P.L.C., P.O.BOX 8910, RESTON, VA, 20195, US

(21) Appl. No.: 11/633,430

(22) Filed: Dec. 5, 2006

(30) Foreign Application Priority Data
Dec. 6, 2005 (DE) 10 2005 058 217.6

(51) Int. Cl. G06K 9/00

(52) U.S. Cl. 382/131

(57) ABSTRACT

At least one nonlinear filter is used, in at least one embodiment, on reconstructed tomographic display data of a patient. The display data thus filtered serves the purpose of computer aided detection of high contrast objects. Moreover, in at least one embodiment, a system is disclosed for computer aided detection of high contrast objects in tomographic displays of a patient, preferably in CT, NMR or tomographic ultrasound displays. The system includes at least one recording apparatus and at computer with computer programs for operating the system, in the case of which at least one nonlinear filter is applied to reconstructed tomographic display data of a patient in order subsequently to use these filtered display data to carry out computer aided detection of high contrast objects.

### PRIORITY STATEMENT

The present application hereby claims priority under 35 U.S.C. §119 on German patent application number DE 10 2005 058 217.6 filed Dec. 6, 2005, the entire contents of which is hereby incorporated herein by reference.

### Field

Embodiments of the invention generally relate to a method and/or a system for computer aided detection of high contrast objects in tomographic pictures of a patient, in particular for the use of a special filter.

### BACKGROUND

A method and a system for a computer aided detection of high contrast objects in tomographic pictures are generally known. With the aid of tomographic pictures, a computer aided search is made in this case for lesions, for example in the lung or in the colon, and if appropriate criteria hold true the lesions are displayed in a suitable way to the operating staff on the display screen. High contrast objects in the meaning of embodiments of the invention are spoken of when tissue contours are displayed with the aid of a contrast agent—such as air, iodine containing or lanthanide containing liquid—that exhibits a greatly different absorption behavior by contrast with human tissue.

For example, such investigation methods are described in document U.S. Pat. No. 6,556,696 B1 or in the German patent application (not yet a prior publication) with the file reference DE 10 2004 060 931.4-35.

In the case of the methods shown there, the lesions found with the aid of computers are displayed to the operating staff in different display variants on a display screen, the operating staff viewing these lesions, for example polyps in the intestine, and obtaining findings for their pathological relevance.

There is the problem in this mode of procedure that, on the one hand, lesions actually present are to be detected in any case, that is to say the sensitivity of the automatic detection must be set relatively high while, on the other hand, the time expenditure for the subsequent manual findings rises steeply given the very high number of false positive results associated therewith, in particular for data records with a low dose.

In at least one embodiment of the invention, the method known per se is improved for automatically detecting high contrast objects in tomographic pictures such that, on the one hand, the number of false positive detections is reduced, but on the other hand the lesions detected as true positive are not worsened in the process.

Because of the continuous effort to carry out radiological examinations with the least possible dose commitment for the patient, and because of the property that the lesions being sought are high contrast objects, very low doses are frequently used in computer tomography. The noise thereby present in the volume data renders more difficult the ability to diagnose in low contrast objects. Random findings, for example, from liver lesions in CT data records of the colon are therefore no longer possible, or possible only with great limitations. In order to improve the detectability of such low contrast objects, it is known to use nonlinear edge-preserving filters that yield a clear improvement in diagnosis.

Computer aided automatic detection (CAD, computer aided detection) of high contrast objects, for example of lesions in the lung or in the colon, finds defective results, that is to say “false positive” lesions, in addition to the actual “true positive” lesions being sought. The defective results must be examined manually in addition just like the actual lesions. A high false positive rate therefore leads to a time-consuming diagnosis and is therefore undesirable. One goal of the development of CAD algorithms is to find as many lesions as possible and at the same time to keep the number of false positive results as low as possible. The cause of the undesired CAD results resides firstly in the fact that there are present in the body structures with similar features to which the CAD algorithm is optimized. Secondly, however, deficiencies in the measurement such as, for example, movement artifacts or noise due to low doses in computer tomography lead to the false positive results.

It has been shown surprisingly that in the conditioning of reconstructed volume data that are being used in CAD algorithms the use of digital filters that are originally provided to suppress noise in medical image data can reduce the number of false positive results without influencing the search results of the actual lesions (true positives).

Simple linear lowpass filters can certainly suppress noise very efficiently, but in this process smaller structures are also disturbed in such a way that the downstream CAD algorithm can no longer find the lesions being sought with the required quality. The true positive results are thus unfavorably influenced. This renders these filters unusable.

Nonlinear filters, in particular edge-preserving nonlinear low pass filters that suppress noise without substantially influencing edges and thus the structures, have proved to be favorable for application with CAD algorithms. For example, the filters can be used in conjunction with algorithms for automatically detecting pulmonary nodules or intestinal polyps, these algorithms referring to high contrast objects, that is to say to pulmonary nodules in the air filled lung or to intestinal polyps in the air filled intestine. Consequently, the surfaces of the lesions being sought are not influenced, or are influenced only insubstantially, by the proposed filter, and no influence is exerted on the detection rate of the actual lesions.

In an examination of 9 data records (9-80 mAs, mean value 21 mAs) a reduction from 46 false positive to 34 false positive results was found, for example. This corresponds to a reduction by approximately 25%, no influence having been determined on the two positive results. No significant improvement could be achieved in 9 further data records (80-165 mAs, mean value 102 mAs).

Thus, the inventor has recognized that the application of filters known per se that serve for improving the display of visual low contrast pictures, preferably of edge-preserving filters, after an application to the tomographic displays that are used for computer aided detection of lesions greatly reduces the number of lesions detected as false positive after the application of this filter, whereas at the same time the number of the lesions detected as true positive is not influenced thereby.

Consequently, the inventor proposes the use of at least one nonlinear filter on reconstructed tomographic display data of a patient, the tomographic display data thus filtered serving for computer aided finding of high contrast objects. It has emerged that such an application of at least one suitable nonlinear filter to tomographic data before they are processed with the algorithms of an automatic finding system leads to a reduction in false positive findings.

This effect is particularly pronounced when the at least one nonlinear filter is an edge-preserving filter. It is also simultaneously avoided thereby that the true positive findings are unfavorably influenced. The use of a combination of at least one linear and/or at least one nonlinear filter is particularly advantageous.

A similar edge-preserving filtering that, according to at least one embodiment of the invention, can be used in the context with the computer aided diagnosis is described, for example, in the German patent application of file reference DE 10 2004 008 979.5-53, the entire contents of which is hereby incorporated herein by reference.

In a particular variant embodiment, the inventor proposes in particular terms that for the tomographic display of the patient use be made of a volume model that divides the volume of the patient into a multiplicity of three-dimensional image voxels with individual image values in accordance with a first data record with original image voxels, and the image value of each voxel represents an object-specific property of the examination object in this volume, the variances of the image values in a prescribed range or radius R being calculated for each image voxel after the reconstruction of the total volume, the direction of the largest variance being determined for each image voxel in order to detect contrast discontinuities and their spatial orientation with their tangent planes T, and the direction of the smallest variance being determined for each image voxel in the tangent plane. The filtering is fashioned in this case such that the original image voxels are processed with the aid of a 2D filter, which is the same over the entire image area, and two different linear filters with selected directions that result from the extremes of the previously calculated variances, three data records with differently filtered image voxels are produced, and the original image voxels and the filtered image voxels are mixed by using local weights to form a result image.

A strong suppression of noise and the simultaneous preservation of the sharpness of the structures is achieved by way of this specific filtering and with minimal computing time, and so only a few false positive results are still to be noted in the subsequent computer aided analysis of the structures.

Such filtering is described in another context in the German patent application DE 10 2005 038 940.6, which is not a prior publication, and which the entire contents thereof are hereby incorporated herein by reference.

In a particular design, the inventor proposes to carry out a two-dimensional isotropic convolution as 2D filter on two-dimensionally flat voxel sets, a second data record of voxels I_{IF} being produced. Such an isotropic convolution can be executed in the spatial domain, but it is more advantageous to execute this isotropic convolution in the frequency domain, here using a Fourier transformation to transfer the first data record in planar fashion in accordance with the orientation of the 2D filter that is the same over the entire image area into a frequency domain, multiplying it there by the isotropic 2D filter function and thereafter back transforming it into the spatial domain.

According to at least one embodiment of the invention, it is possible to apply to the first data record a first local and linear filter that is respectively aligned in the direction of the local minimum variance \vec{v}ₘᵢₙ and generates a third data record of voxels I_{ALF,min}.

Correspondingly, a second linear, locally variable filter aligned perpendicular to the tangent plane T can be used, the perpendicular to the tangent plane being determined by \vec{v}_{⊥}=\vec{v}ₘᵢₙ×\vec{v}ₘₐₓ, and the fourth data record of voxels I_{ALF,max} being generated by applying it. With reference to this filtering, it is expressly pointed out that said locally variable filter can also be identical at all voxels.

In order to ensure the normalization of the result data record, when mixing the four data records, the first data record I_{org} can be subtracted in a weighted fashion from the weighted sum of the second to fourth data records I_{IF}, I_{ALF,min} and I_{ALF}, ⊥.

With reference to the weighting, the weighting in the mixing of the four data records can be set as a function of the isotropy and/or anisotropy of the immediate surroundings of the image voxel considered and of the local variance.

It is particularly advantageous in this case when the weighted mixing of the four data records is carried out in accordance with the following formula:
I_{final}=(1−w)·I_{orig}+w·[w^{3D}·I_{3D}+(1−w^{3D})·I_{2d}], where
I_{3d}=I_{IF}+I_{ALF,min}−I_{orig} and
I_{2d}=w^{IF}·I_{IF}+(1−w^{IF})·[I_{ALF,min}+w^{⊥}·(I_{ALF,⊥}−I_{orig})],
the weighting factors having the following meaning:
w measure of the minimum local variance vₘᵢₙ at the pixel considered,
w^{3D} measure of the anisotropy η^{3D} in three-dimensional space,
w^{IF} measure of the anisotropy η^{IF} in the plane of the filter I_{IF}, and
w^{⊥} measure of the anisotropy η^{⊥} in the directions v_{⊥} and vₘᵢₙ.

Here, the anisotropy η^{3D} in three-dimensional space can be calculated using the formula

$${η}^{3 D} = \frac{{v}_{max} - {v}_{min}}{{v}_{max} + {v}_{min}} ,$$

it being possible to produce the weighting factor w^{3D} from w^{3D}=1−η^{3D}, for example.

The anisotropy η^{IF} in the plane of the filter I_{IF} can be calculated using the formula:

$${η}^{IF} = \frac{{v}_{max}^{IF} - {v}_{min}^{IF}}{{v}_{max}^{IF} + {v}_{min}^{IF}} ,$$

vₘₐₓ^{IF} and vₘᵢₙ^{IF} representing the maximum and minimum variances from the directions of the filter I^{IF}. Here, as well, the weighting factor w^{IF} can be calculated from w^{IF}=1−η^{IF}, for example.

Moreover, the anisotropy η^{⊥} in the directions v_{⊥} and vₘᵢₙ can be represented by the formula:

$${η}^{⊥} = \frac{{v}_{⊥} - {v}_{min}}{{v}_{⊥} + {v}_{min}} ,$$

it advantageously being possible to calculate the weighting factor w^{⊥} from w^{⊥}=1−η^{⊥}.

It is expressly pointed out that different functional relationships of the weighting factors with the respectively named relevant variance are possible, and the relationships are only exemplary. It would likewise also be possible to use any desired, if appropriate linear, function, for example w=aη^{b}+c or similar, it being possible to give the user the possibility to adapt the parameters if appropriate for an optimum filter result.

### BRIEF DESCRIPTION OF THE DRAWINGS

Embodiments of the invention are described in more detail below with the aid of the figures, only the features required to understand the invention being illustrated. The following reference symbols are used in this case: 1: CT system; 2: X-ray tubes; 3: detector; 4: optional second X-ray tubes; 5: optional second detector; 6: gantry housing; 7: patient; 8: patient couch; 9: system axis; 10: control and arithmetic logic unit; 11: memory of the control and arithmetic logic unit; 12: reconstructed volume display; 13: edge detection; 14: axially isotropic filter; 15: adaptive linear filtering in direction v_{⊥}; 16: adaptive linear filtering in direction vₘᵢₙ; 17: mixing with local weights; 18: filtered tomographic display or volume display; 19: computer aided detection of the lesions; 20: filter; I: sagital tomographic display of the area of interest; II: axial tomographic view of the area of interest; III: virtual endoluminar view of the area of interest; IV: three-dimensional segmented overview display of the colon.

Individually in the drawings:

FIG. 1 shows a CT system according to an embodiment of the invention having a control and arithmetic logic unit and a schematic illustration of an exemplary filtering before the computer aided detection of lesions,

FIG. 2 shows a screen excerpt of a lesion found to be falsely positive,

FIG. 3 shows a screen excerpt of the same site after filtering according to an embodiment of the invention, the false positive detection being suppressed as a result,

FIG. 4 shows a screen excerpt from another area with positive detection of a lesion without prior filtering, and

FIG. 5 shows a display of a screen excerpt of the site from FIG. 4, but after prior filtering and with retention of the positive detection of this lesion.

### DETAILED DESCRIPTION OF THE EXAMPLE EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referencing the drawings, wherein like reference numerals designate identical or corresponding parts throughout the several views, example embodiments of the present patent application are hereafter described.

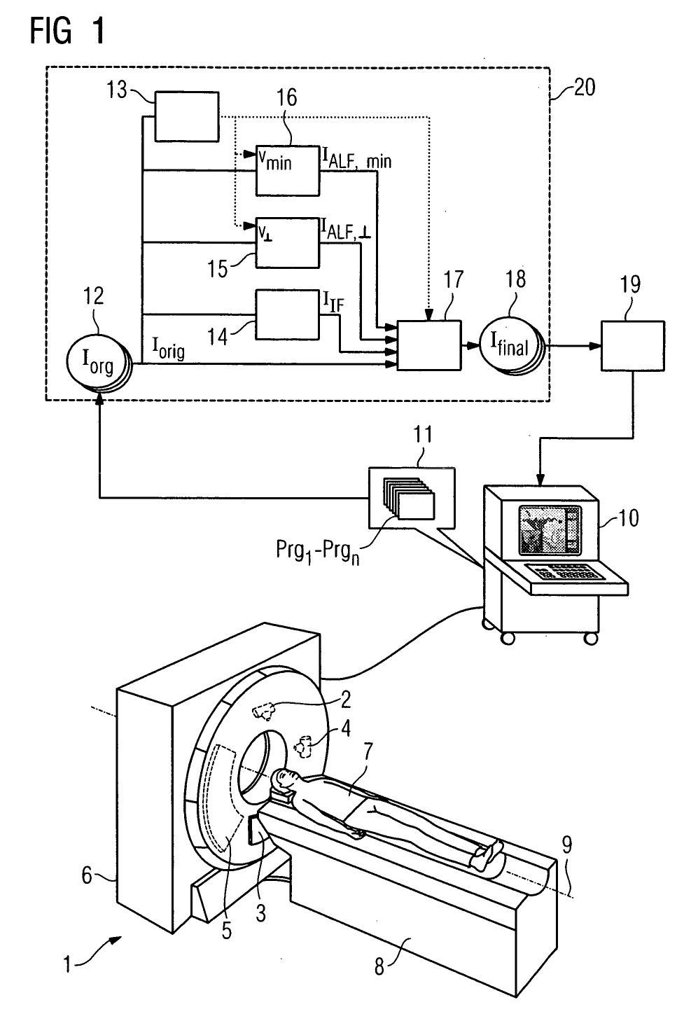

FIG. 1 shows a preferred example embodiment of the application of nonlinear filtering in conjunction with a computer tomography system. The computer tomography system 1 has an X-ray tube 2 that is arranged opposite a detector 3 on a gantry in a gantry housing 6. It is optionally possible in addition for a further X-ray/detector system, consisting of a further X-ray tube 4 and a further detector 5, to be fastened on the gantry such that the scanning and data acquisition can also take place via more than one X-ray/detector system. The patient 7 is located on a patient couch 8 that can be displaced along the system axis 9, such that during the rotation of the X-ray/detector system 2, 3 the patient can be pushed through the scanning area and a spiral scanning of the patient takes place.

The control of the system and the evaluation of the detector data including the reconstruction of tomograms or volume data are performed via the control and arithmetic logic unit 10 in which—symbolically illustrated—there are stored in the memory 11 programs Prg₁ to Prgₙ that are executed as required. The volume data 12 reconstructed by these programs are conditioned according to an embodiment of the invention in the filter procedure that is illustrated here by a dashed rectangle 20. To this end, an edge detection is carried out on the basis of these volume data records 12 in method step 13, the directions of the vectors of the minimum and maximum variances vₘᵢₙ and vₘₐₓ being determined, and the direction of v_{⊥} being determined.

The filtering of the original image data is now performed in method steps 14, 15 and 16—in accordance with the following rule:

Method step 14 relates to filtering of the axial planes with a fixed 2D filter. For example, it is possible in this case to carry out a two dimensional, isotropic convolution on two dimensional flat voxel sets equivalently in the frequency domain. To this end, the axial images are transformed with the aid of a Fourier transformation into the frequency domain, multiplied there by an isotropic 2D filter function and thereafter transformed again into the spatial domain. It is to be pointed out that it is also possible as an alternative to execute a convolution directly in the spatial domain, it being possible to execute one or other variant more quickly depending on the hardware in use.

Such a filtering is the same for the entire data record, and the result is now stored in the new data record I_{IF}. Furthermore, two locally different filterings are carried out in steps 15 and 16, their local differences being a function of the directions of the vectors vₘᵢₙ and v_{⊥}.

A linear filtering in the v_{⊥} direction is performed in method step 15 via a convolution with a one-dimensional core, it being possible for the latter to be the same for the entire data record, and only the direction of the filter corresponding to the direction of the vector v_{⊥} being different.

A linear filtering likewise takes place correspondingly in method step 16, but here in the direction of the vector vₘᵢₙ. This can also be performed by way of a convolution with a one-dimensional core that, if appropriate, is identical over the entire data record, and here, as well, the direction of the filter is locally adapted in accordance with the direction of the minimum variance vₘᵢₙ. Thus, the two method steps 15 and 16 produce new data records I_{ALF,I} and I_{ALF,min} which are subsequently further processed.

In the further processing, the mixing of the four existing data records I_{IF}, I_{ALF,⊥} and I_{ALF,min} with I_{orig} is now performed in method step 17, the weights of the mixing being a function of the surroundings of the respectively viewed voxels. The following principles are observed in this mixing:

If the surroundings of a voxel are isotropic, that is to say if the values of vₘᵢₙ and vₘₐₓ are comparable, a 3D filter can be used efficiently for smoothing. Since such a filter is not available, a suitable combination is formed with the aid of the data records I_{IF} and I_{AF}. Here, the subtraction of the original voxel is required so that the latter is not counted twice. The fraction of the components subjected to pseudo-3D filtering in this way is calculated as a function of the isotropy, the weight being intended to be small given a large measure of anisotropy, and vice versa.

If an anisotropy is established, it is possible to design a 1D to 2D filter that is adapted to the local conditions. The anisotropies in the axial and the vₘᵢₙ/v_{⊥} plane are taken into account to this end. If an isotropic situation is present in one of these planes, a “pseudo-2D filter” is combined from the filters present. In the event of a higher measure of anisotropy, a one-dimensional filter in the direction of vₘᵢₙ is left over.

The total weight of the previously named contributions is set as a function of the local variance, a large variance signifying a low weight, and vice versa. The fact that the eye perceives noise more weakly in the vicinity of high contrast structures is utilized in this case. At the same time, it is possible in this way to ensure that small high contrast structures are obtained. The local variance vₘᵢₙ is used here as measure, since it is free from structural noise.

This filtering calculates new volume data records or image data records 18 that are transformed according to the invention in method step 19 in which the actual computer aided detection known per se of high contrast objects is performed. These high contrast objects, that is to say the lesions found, are then displayed on a display of the arithmetic and control unit 10. As a rule, the operating staff will now check the lesions found with the aid of the computer, and assess them for diagnostic relevance. It is important in this case that the upstream filtering operation according to at least one embodiment of the invention greatly reduces the number of lesions found to be false positive, while at the same time lesions detected as being true positive are not suppressed by this additional filtering process.

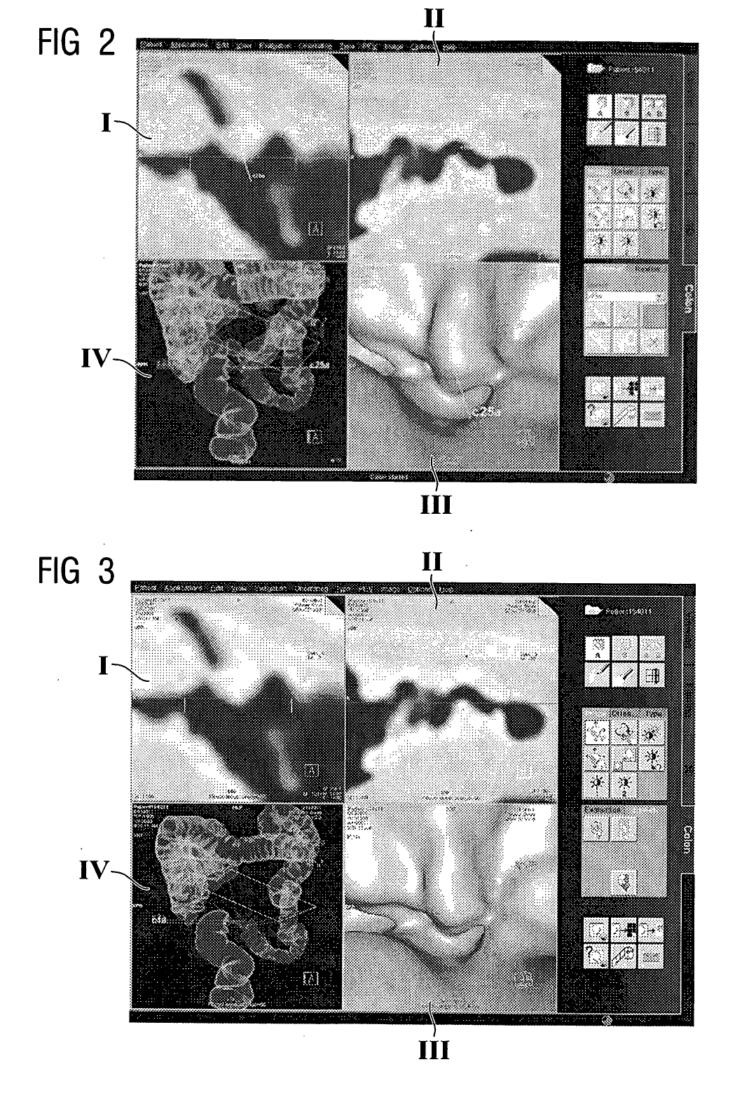

FIGS. 2 to 5 display example image excerpts of different situations with or without the filtering according to the invention before the computer aided detection.

FIG. 2 shows an image excerpt from a computer aided detection of a lesion. The left quadrant I shows a sagital section through a found lesion that has been named here as c25a. An axial section through this found lesion c25a is illustrated in the second quadrant II. The third quadrant III shows a virtual endoluminar view that is obtained from the CT data. Finally, the fourth quadrant IV is an overview display of the examined colon with the indicated position of the lesion c25a found as false positive.

In the case of FIG. 2, the computer aided analysis of the colon has probably detected a residual stool in the colon as a false positive lesion and indicated the latter for a manual control finding.

If the CT display used operates with a nonlinear filter before the computer aided finding, the situation in FIG. 3 arises. There, the same site from FIG. 2 is shown once more, it being possible to detect that the computer program no longer indicates any lesion at this site.

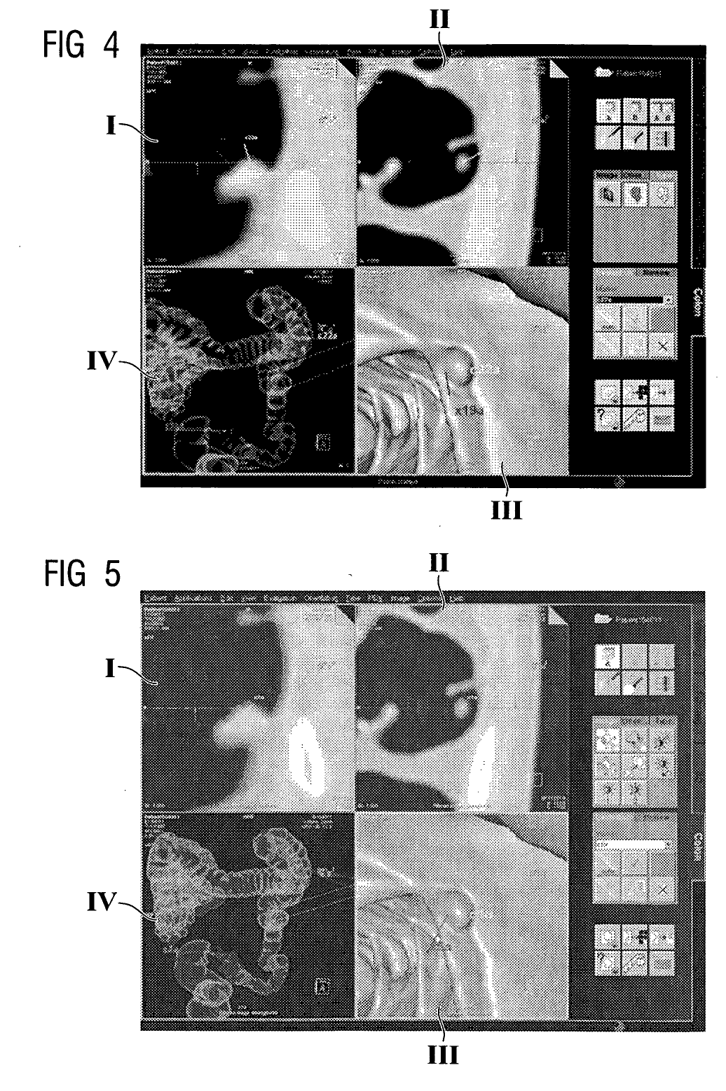

FIG. 4 shows a further site in the colon, FIG. 4 showing, without the prior filtering according to the invention, a lesion c22a that was actually also found via the manual finding, as may be detected from the marking x19a.

FIG. 5 again shows the same site from FIG. 4, with edge-preserving nonlinear filtering having been carried out here over the CT display. Despite filtering, this site, too, is found as a lesion, here c1a, via the analysis program. Positive results are thus not suppressed by the additional filtering.

A statistical examination revealed that owing to the inventive prefiltering of the CT display that was used for the computer aided detection of lesions, the analysis software really did determine significantly fewer false positive results, while the number of lesions found to be true positive was not influenced by this filtering.

It goes without saying that the above-named features of embodiments of the invention can be used not only in the respectively specified combination, but also in other combinations or on their own, without departing from the scope of the invention.

Further, elements and/or features of different example embodiments may be combined with each other and/or substituted for each other within the scope of this disclosure and appended claims.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for computer aided detection of high contrast objects in X-ray computer tomography, comprising:
applying, before the computer aided detection of the high contrast object, at least one nonlinear filter to reconstructed tomographic display data of a patient.

2. The method as claimed in claim 1, wherein the at least one nonlinear filter is an edge-preserving filter.

3. The method as claimed in claim 1, wherein a combination of at least one of linear and nonlinear filters is applied.

4. The method as claimed in claim 1, wherein, in order to generate the tomographic display data, use is made of a volume model that divides the examination volume into a multiplicity of three-dimensional image voxels with individual image values in accordance with a first data record with original image voxels (I_{org}), and
the image value of each voxel represents an object-specific property of the patient in the examination volume,
the variances of the image values in at least one of a prescribed range and radius being calculated for each image voxel after the reconstruction,
the direction of the largest variance (\vec{v}ₘᵢₙ) being determined for each image voxel in order to detect contrast discontinuities and their spatial orientation with their tangent planes,
the direction of the smallest variance (\vec{v}ₘᵢₙ) being determined for each image voxel in the tangent plane,
the original image voxels (I_{org}) being processed with the aid of a 2D filter, which is the same over the entire image area, and two different linear filters with selected directions that result from the extremes of the previously calculated variances (\vec{v}ₘᵢₙ,\vec{v}ₘₐₓ), three data records with differently filtered image voxels (I_{IF}, I_{ALF,min} and I_{ALF}, ⊥) being produced, and
the original image voxels (I_{org}) and the filtered image voxels (I_{IF}, I_{ALF,min} and I_{ALF,X}) being mixed by using local weights to form a result image (I_{final}).

5. The method as claimed in claim 4, wherein a two-dimensional isotropic convolution is carried out as 2D filter on two-dimensionally flat voxel sets, and a second data record of voxels is produced.

6. The method as claimed in claim 5, wherein the isotropic convolution is executed in the spatial domain.

7. The method as claimed in claim 5, where-in the isotropic convolution is executed in the frequency domain.

8. The method as claimed in claim 7, wherein the isotropic convolution is executed in the frequency domain by using a Fourier transformation to transfer the first data record in planar fashion in accordance with the orientation of the 2D filter that is the same over the entire image area into a frequency domain, multiplying it there by the isotropic 2D filter function and thereafter back transforming it into the spatial domain.

9. The method as claimed in claim 4, wherein the first linear filter is locally variable and is aligned in the direction of the local minimum variance(\vec{v}ₘᵢₙ), a third data record of voxels (I_{ALF,min}) being produced.

10. The method as claimed in claim 4, wherein the second linear filter is locally variable and is aligned perpendicular to (\vec{v}ₘᵢₙ) and(\vec{v}ₘᵢₙ), and the fourth data record of voxels (I_{ALF,max}) is produced.

11. The method as claimed in claim 4, wherein, when mixing the four data records, the first data record (I_{org}) is subtracted in a weighted fashion from the weighted sum of the second to fourth data records (I_{IF}, I_{ALF,min} and I_{ALF}, ⊥).

12. The method as claimed in claim 4, wherein the weighting in the mixing of the four data records is set as a function of the isotropy/anisotropy of the immediate surroundings of the image voxel considered and of the local variance.

13. The method as claimed in claim 4, wherein the weighted mixing of the four data records is carried out in accordance with the following formula:
I_{final}=(1−w)·I_{orig}+w·[w^{3D}·I_{3D}+(1−w^{3D})·I_{2d}], where
I_{3d}=I_{IF}+I_{ALF,min}−I_{orig} and
I_{2d}=w^{IF}·I_{IF}+(1−w^{IF})·[I_{ALF,min}+w^{⊥}*(I_{ALF,⊥}−I_{orig})]
the weighting factors having the following meaning:
w measure of the minimum local variance vₘᵢₙ at the pixel considered,
w^{3D} measure of the anisotropy η^{3D} in three-dimensional space,
w^{IF} measure of the anisotropy η^{IF} in the plane of the filter I_{IF}, and
w^{⊥} measure of the anisotropy η^{⊥} in the directions v_{⊥} and vₘᵢₙ.

14. The method as claimed in claim 13, wherein the anisotropy η^{3D} in three-dimensional space is calculated using:
$${η}^{3 D} = \frac{{v}_{max} - {v}_{min}}{{v}_{max} + {v}_{min}}$$

15. The method as claimed in claim 14, wherein the weighting factor w^{3D} is calculated using w^{3D}=1−η^{3D}.

16. The method as claimed in claim 14, wherein the anisotropy η^{IF} in the plane of the filter I_{IF} is calculated using:
$${η}^{IF} = \frac{{v}_{max}^{IF} - {v}_{min}^{IF}}{{v}_{max}^{IF} + {v}_{min}^{IF}}$$
vₘₐₓ^{IF} and vₘᵢₙ^{IF} representing the maximum and minimum variances in the plane of the filter I^{IF}.

17. The method as claimed in claim 14, wherein the weighting factor w^{IF} is calculated using: w^{IF}=1−η^{IF}.

18. The method as claimed in claim 14, wherein the anisotropy η^{⊥} in the directions v_{⊥} and vₘᵢₙ is calculated using:
$${η}^{⊥} = \frac{{v}_{⊥} - {v}_{min}}{{v}_{⊥} + {v}_{min}}$$

19. The method as claimed in claim 14, wherein the weighting factor w^{⊥} is calculated using: w^{⊥}=1−η^{⊥}.

20. A system for computer aided detection of high contrast objects in tomographic displays of a patient, comprising:
at least one recording apparatus; and
a computer with computer programs for operating the system, wherein program code is included which, when executed on the computer, simulates the method steps of claim 1 during operation.

21. The method as claimed in claim 1, wherein the at least one nonlinear filter includes an edge-preserving filter.

22. The method as claimed in claim 2, wherein a combination of at least one of linear and nonlinear filters is applied.

23. The method as claimed in claim 15, wherein the anisotropy η^{IF} in the plane of the filter I^{IF} is calculated using:
$${η}^{IF} = \frac{{v}_{max}^{IF} - {v}_{min}^{IF}}{{v}_{max}^{IF} + {v}_{min}^{IF}}$$
vₘₐₓ^{IF} and vₘᵢₙ^{IF} representing the maximum and minimum variances in the plane of the filter I^{IF}.

24. The system as claimed in claim 20, wherein tomographic displays of the patient are at least one of CT, NMR and tomographic ultrasound displays.

25. A system for computer aided detection of high contrast objects in tomographic displays of a patient, comprising:
at least one recording apparatus; and
a computer with computer programs for operating the system, wherein program code is included which, when executed on the computer, simulates the method steps of claim 14 during operation.
